(19) United States
(12) Patent Application Publication
(10) Pub. No.: US 2014/0329299 A1
(43) Pub. Date: Nov. 6, 2014

(54) METHOD AND PLANT FOR SEPARATING CARBON DIOXIDE FROM CRUDE GASES CONTAINING METHANE

(71) Applicant: DGE DR ING. GUENTHER ENGINEERING GMBH, WITTENBERG (DE)

(72) Inventor: Lothar Guenther, Geretsried (DE)

(21) Appl. No.: 14/365,692

(22) PCT Filed: Dec. 16, 2011
(86) PCT No.: PCT/DE2011/002152

§ 371 Date: Jul. 14, 2014

(51) Int. Cl. B01D 53/14

(52) U.S. Cl. CPC B01D 53/1462
USPC 435/266; 95/177; 95/163; 95/174; 96/234; 435/294.1

(57) ABSTRACT

A method for removing carbon dioxide from methane-containing crude gases, especially biogas, by pressure scrubbing, using a physical solvent, includes circulating the contaminated scrubbing solution after regeneration. A plant suitable for carrying out the method considerably reduces the methane loss which arises through methane slippage and improves the overall energy balance of the method. Laden scrubbing solution obtained from the pressure scrubbing is treated at least in one flash stage before the first stripping stage. In addition, a nitrogen, oxygen, carbon dioxide and methane-containing gas mixture drawn off from the flash stage is cleaned in a scrubbing stage by purified scrubbing solution drawn off from the second stripping stage and supplied in countercurrent, forming a high-purity methane gas.

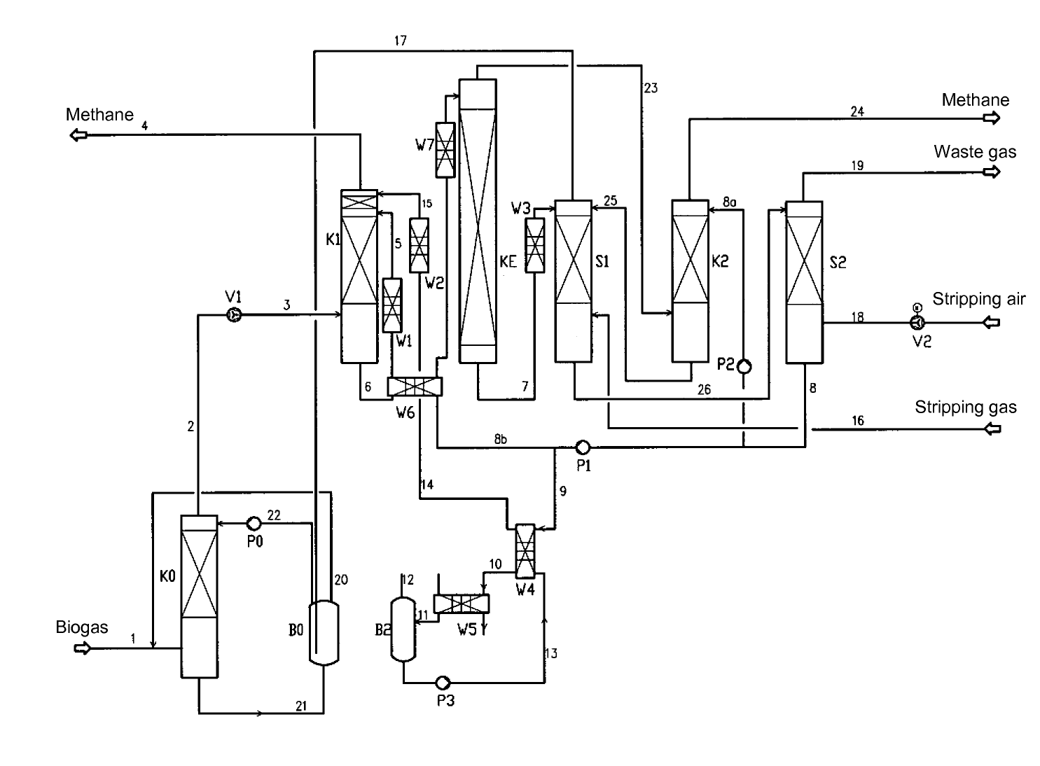

The invention relates to a method of removing carbon dioxide from crude gases containing methane, especially biogas, by pressure scrubbing, using a physically acting solvent wherein the contaminated scrubbing solution is circulated in the circuit after regeneration. In addition, the invention relates to a suitable plant for carrying out the method.

Pressure scrubbing processes for removing carbon dioxide from crude gases containing methane, especially biogas, are based on the operating principle of the solution of gases in liquids.

Methods of purifying crude or biogas are known from DE 10 2008 025 971 A1 and DE 10 2008 060 3 0 A1 which use water as a scrubbing solution to remove CO₂. In order to reduce the methane losses occurring methane dissolved in the scrubbing solution is separated from the contaminated scrubbing solution in a plurality of downstream purifying steps by means of stripping air or stripping air and oxygen, producing an oxygenic stripping gas of combustion quality.

A method known as the Selexol process in which polyglycol ethers, especially glycol dimethyl ethers, are used as physically acting solvents is also known from practice as a pressure scrubbing method.

A major advantage of this method over pressure water scrubbing is that CO₂ is significantly more soluble in the scrubbing liquid (Selexol), thereby considerably reducing consumption. A disadvantage of this scrubbing liquid is that organic and inorganic compounds are significantly more soluble in it than in water.

A further major disadvantage is that the contaminated scrubbing liquid can be regenerated only at temperatures between 55 and 80° C. and comparatively high methane losses and losses of other organic combustible substances occur, up to 0.1% of which are contained in biogas.

The objective of the invention is to devise a method of removing carbon dioxide from crude gases containing methane, especially biogas, by means of pressure scrubbing with a physically active scrubbing agent in which the methane loss due to methane slip is considerably reduced and the overall energy balance of the method is improved.

This objective is achieved according to the invention, by means of the features specified in claim 1. Advantageous procedural developments are the subject matter of claims 2 to 14. A plant suitable for carrying out the method is the subject matter of claim 14. Claims 16 and 17 relate to additional embodiment variants of the claimed plant.

According to the proposed method the laden scrubbing solution accruing after pressure scrubbing is treated in at least one flash stage upstream of the first stripping stage. The pressurised laden scrubbing solution is preferably depressurised by reducing the system pressure to a value of 1.5 to 5 bar. The temperature of the laden scrubbing solution can be increased by at least 5° C. in the flash column, thereby increasing the removal of methane from the scrubbing solution.

To ensure the method operates economically it is important to incorporate additionally into the complete plant a scrubbing stage in which the gas mixture containing nitrogen, oxygen, carbon dioxide and methane drawn off from the flash stage is purified by the scrubbing solution drawn off from the second stripping stage and supplied in countercurrent. This flash gas has a methane content of 20 to 40% and constitutes at least 7% of the total methane content. By treating this flash gas within the overall plant with a scrubbing solution that has already been purified a methane gas of high purity with a methane content of over 90% by volume is produced that can be utilised for other purposes.

The solubility equilibrium developing causes the following undesired process to take place especially when polyglycol ethers are used as a scrubbing agent component: as the methane content in the biogas increases during pressure scrubbing, more methane is also bound in the scrubbing solution, causing a considerable increase in methane losses. This effect also occurs though to a lesser extent when water is used as a scrubbing agent. 50% less methane is lost when water is used as a scrubbing agent compared with polyglycol ethers.

The proposed measures enable the gaseous components, nitrogen, oxygen, carbon dioxide and methane dissolved in the scrubbing solution in the flash stage to be released as a gas mixture and carbon dioxide to be scrubbed out of the gas mixture by the purified scrubbing solution circulated in the circuit so that highly pure methane gas can be drawn off at the head of the scrubbing column. The methane slip in the entire system can therefore be reduced to a value of under 0.2%. Only a smaller partial quantity of purified scrubbing solution is required for the scrubbing process. The larger partial quantity is used for the pressure scrubbing.

A further disadvantage of existing methods of removing carbon dioxide from biogas by means of scrubbing solutions containing glycol ethers is that dew points of only up to 200 to 500 mg water/Nm³ of biogas can be achieved despite the high water absorption of the scrubbing solution. An additional adsorption drying is therefore necessary to achieve the required water content of 50 mg/Nm³ in the biogas.

A partial amount is preferably removed from the purified scrubbing solution accruing in the second stripping stage. This partial amount is then heated to temperatures of over 100° C. and supplied to a vessel in which residual water from the hot scrubbing solution is expelled. After cooling, the scrubbing solution, which is almost anhydrous, is re-added to the purified scrubbing solution. The energy required to heat the scrubbing solution is recovered from within the plant.

The economy of the overall method of purifying biogas with a scrubbing solution containing glycol ethers is therefore significantly improved.

An anoxic or oxygenic gas and precompressed air are used as a stripping gas in the first stripping stage and in the second stripping stage respectively. This is dependent on the oxygen demand required for an upstream desulphurisation.

The residually laden scrubbing solution accruing at the bottom of the first flash column and the laden scrubbing solution accruing at the bottom of the scrubbing column of the scrubbing stage are supplied to the first stripping column of the first stripping stage. The oxygenic stripping gas supplied is used at a quantity of 0.1 to 2%, based on the amount of biogas to be purified that is supplied to the pressure scrubber.

The stripping process can be carried out at temperatures of 20 to 120° C. and a pressure of 1.5 to 5 bar. At least 90% of the methane dissolved in the scrubbing solution can therefore be removed.

Laden scrubbing solution from the first stripping stage is supplied to the second stripping stage and depressurised to standard pressure and dissolved carbon dioxide still contained in the scrubbing solution is removed by stripping air to a residual content of at least under 100 mg/l. The scrubbing solution produced in this way is completely regenerated and can be recycled.

The purified scrubbing solution accruing at the bottom of the second stripping column is divided into two partial streams with one partial stream supplied to the scrubbing column and the other supplied to the pressure scrubbing.

In order to ensure the efficiency of the overall method it is important that the crude gas used or biogas is almost completely desulphurised upstream of the actual pressure washing.

The crude gas to be desulphurised is preferably brought into contact with a suspension containing microorganisms wherein the suspension contains dissolved oxygen which reaches the suspension because of the contact between the oxygenic gas mixture drawn off from the first stripping stage and the suspension. The hydrogen sulphide scrubbed out during desulphurisation is oxidised to SO₄ by microorganisms and converted to sulphuric acid. The amount of oxygen required for biological desulphurisation can be metered via the oxygen concentration of the stripping gas supplied to the first stripping stage.

The gas mixture accruing after the first stripping stage is added to the crude biogas in such a quantity that the ratio of gas mixture to crude biogas is 1:3 to 1:20, preferably 1:6 to 1:12.

According to the proposed method carbon dioxide can be removed to a residual content of under 4% by volume in the biomethane and at the same time water can be removed to a value of under 100 mg/Nm³.

Further details about a plant suitable for carrying out the method plant are given in the example below.

The invention is explained below by reference to the functional diagram shown in the drawing of a plant for carrying out the method.

### EXAMPLE 1

The biogas derived from the digester of a biogas plant has the following composition:

| | | |
|---|---|---|
| Methane | 52 | % by volume |
| Carbon dioxide | 44 | % by volume |
| Water | 3.4 | % by volume |
| Hydrogen | 0.05 | % by volume |
| Oxygen | 0.01 | % by volume |
| Nitrogen | 0.2 | % by volume |
| H₂S | 1,200 | ppm |
| NH₃ | 250 | ppm. |

### A: Desulphurisation

Biogas (250 Nm³/h) at a temperature of 38° C. is supplied directly to a biological desulphurisation unit from the digester via the line 01. This unit comprises a scrubbing column K0 as absorber, a reaction vessel B0 and a circuit line 21, 22 into which a first pump P0 is incorporated.

The reaction vessel B0 contains an aqueous suspension comprising microorganisms, the sulphuric acid that has been formed and bound ammonium sulphate.

The pressurised gas mixture drawn off at the head of the first stripping column S1 of the first stripping stage is introduced via a line 17 into the reaction vessel B0 wherein the oxygen contained in the gas mixture is dissolved in the suspension contained in the reaction vessel B0. The gas mixture comprising methane and carbon dioxide reaches the feed line 01 for biogas via a compensating line 20. Hydrogen sulphide (456 g H₂S/h) is scrubbed out of the biogas in the associated scrubbing column K0 by the suspension circulated in the circuit (lines 21, 22) and is bound in the suspension. H₂S is converted to sulphuric acid (H₂S0₄) by the microorganisms contained in the scrubbing column, at the bottom of the column and in the reaction vessel B0 via the intermediate step of sulphate (S0₄²⁻), hydrogen sulphate anion (HSO4⁻). As already mentioned the oxygen required for conversion (912 g/h) is provided by the gas mixture drawn off from the first stripping column.

Additional oxygen can be dosed if required via a higher oxygen concentration of the stripping gas supplied to the first stripping column S1 or by the direct introduction of oxygen into the reaction vessel B0. The temperatures in the scrubbing column K0 and reaction vessel B0 are kept constant at approximately 40° C. The H₂S content is reduced from 1,200 ppm to 15 ppm in the scrubbing column K0. At the same time ammonia contained in the biogas is converted to ammonium sulphate in the sulphuric acid that has been formed, thereby reducing the ammonium content in the biogas from 250 to 2 ppm.

### B: Biogas Pressure Scrubbing K1

The desulphurised biogas drawn off at the head of the scrubbing column K0 via the line 02 is cooled and compressed to 7 bar by a compressor V1 incorporated into the line 02. The increase in temperature (to about 180° C.) of every stage caused by the compression must be reduced again by cooling (to 25° C.). The condensates accruing in the process are separated and the particles contained in the biogas are removed. An activated carbon filter can then be fitted downstream as an option as a fine filter for H₂S.

The biogas pretreated in this way is supplied to an absorber, the scrubbing column K1, via the line 03. The scrubbing column K1 has a column diameter of 450 mm and a column height of 10 m. 7 m of the column height is constructed as a packed bed with two different packing materials. The lower column packing has packing material with a surface of approximately 250 m²/m³ and the upper column packing has packing material with a surface of over 350 m²/m³. The physically active scrubbing solution used comprises tetraethylene glycol dimethyl ether (purity of over 99%, molecular weight of over 280 mol/g, boiling point over 250° C. at standard pressure). The water content is below 1%.

12 m³/h of scrubbing solution at a temperature of 18° C. is supplied to the column K1. Purified biogas (methane gas) with the following composition is drawn off at the head of the scrubbing column K1:

| | | |
|---|---|---|
| Methane | 98.5 | % by volume |
| Carbon Dioxide | 1.08 | % by volume |
| Water | 80 | % by volume |
| Hydrogen | 0.1 | % by volume |
| Oxygen | 0.02 | % by volume |
| Nitrogen | 0.4 | % by volume |
| H₂s | 2 | ppm |
| NH₃ | 1 | ppm. |

The CO₂ content of the biogas is reduced by the pressure scrubbing from 44% by volume to 1.08% by volume. At the same time water is removed from the biogas from 2000 mg/Nm³ to a value of under 50 mg/Nm³.

The purified biogas of the aforementioned quality drawn off via the line 04 at a pressure of 7 bar can be fed as methane gas into any suitable natural gas grid after odorisation and the required calorific value adjustment.

### C: Regeneration of the Laden Scrubbing Solution

The laden scrubbing solution accruing at the bottom of the scrubbing column K1 is regenerated in a flash stage, a first stripping stage, a scrubbing stage and a downstream second stripping stage.

### Flash Stage

The laden scrubbing solution (18 g/l CO₂ and 1.2 g/l CH₄) drawn off at the bottom of the pressure scrubbing column K1 via the line 06 at a temperature of 20° C. is pumped through a first heat exchanger W6 and a second heat exchanger W7 to the head of an flash column KE, with the system pressure reduced from 7 bar to 3 bar. An increase in temperature of the scrubbing solution in the second heat exchanger W7 by at least 5° C. to 25° C. results in the CO₂ and CH₄ contents dissolved in the scrubbing solution being released by a so-called flash depressurisation after the introduction of the scrubbing solution into the flash column KE solution via an immersion pipe, with the released CO₂ acting as a stripping gas. The CO₂ and CH₄ contents are reduced to 15.4 g/l CO₂ and 0.48 g/l CH₄ respectively in the scrubbing solution.

The gas mixture forming (12 Nm³/h CH₄ and 16 Nm³/h CO₂) is drawn off at the head of the flash column KE via the line 23 and supplied to a scrubbing column K2.

The laden scrubbing solution is drawn off via the line 07 and supplied to a first stripping column S1. As an option the temperature of the scrubbing solution can be increased via a heat exchanger W3 incorporated into the line 07 to improve stripping performance.

### First Stripping Stage

Laden scrubbing solution from the flash column KE and laden scrubbing solution from the second scrubbing column K2 are supplied to the first stripping column S1 via the line 07 and the line 25 respectively. The pressure is reduced slightly by approximately 0.5 bar to 2.5 bar in the first stripping column S1, enabling the laden scrubbing solutions from the flash column KE and the second scrubbing column K2 to be introduced without an additional pump at the head of the stripping column S1. The stripping process is carried out with an oxygenic stripping gas with an oxygen content of 1 to 2 Nm³/h. The stripping gas is supplied via the line 16. CO₂ and CH₄ are stripped out of the laden scrubbing solution comprising the two aforementioned partial streams (via the lines 07 and 25).

The scrubbing solution (15 m³/h) drawn off at the bottom of the column still has a residual loading of 14.1 g/l CO₂ and 0.01 g/l of CH₄.

The gas mixture (18 Nm³/h) drawn off at the head via the line 17 has a composition of 49.8% by volume of CH₄, 44.6% by volume of CO₂ and 5.6% by volume of O₂ and is supplied to the vessel B0 as previously mentioned above.

### Scrubbing Stage

A partial stream of purified scrubbing solution from the second stripping column S2 is supplied to the scrubbing column K2 via the lines 08 and 08a into which a pump P2 is incorporated. The gas mixture (12 Nm³/h CH₄ and 16 Nm³/h CO₂), which is drawn off from the flash column KE at a pressure of 3 bar at 3 m³/h and serves as a stripping gas, is supplied via the line 23. The CO₂ contained in the gas mixture is bound in the purified scrubbing solution in this process. The scrubbing solution at the bottom of the column has a loading of 10.3 g/l CO₂ and 0.26 g/l CH₄. As mentioned already, this scrubbing solution is supplied to the first stripping column 51 via the line 25.

Highly pure methane (10.92 Nm³/h CH₄ and 0.1 Nm³/h CO₂) is drawn off at the head of the scrubbing column K2 via the line 24. This methane gas (biomethane) has a purity of 99.1% by volume and a water content of 45 mg/Nm³. H₂S and NH₃ contents were no longer detectable in this highly pure methane gas.

### Second Stripping Stage

In this stage the scrubbing solution still with a residual loading from the first stripping column S1 is supplied to the second stripping column S2 via the line 26 and depressurised to standard pressure. Stripping air is supplied by a second compressor V2 via the line 18. The dissolved CO₂ and CH₄ content is removed from the scrubbing solution in the second stripping column S2. Waste gas is drawn off at the head of the stripping column S2 via the line 19. The purified scrubbing solution exiting via line 08 has only a low residual loading of under 0.1 g/l CO₂ and 0.001 g/l CH₄. Only 0.2 Nm³/h methane is therefore lost by emission from the system to the surroundings via the line 19 of the second stripping column S2. The methane loss is only 0.15% at a rate of production of 130 Nm³/h of methane in a biogas plant.

As already mentioned, a partial stream of the purified scrubbing solution is pumped into the scrubbing column K2 via the line 08a and the other partial stream is conducted via the line 08b by the pump P1 through the first heat exchanger W6 as a heat carrier and re-introduced via the line 05 into the scrubbing column K1 of the pressure scrubbing after it has cooled to 18° C. in the second heat exchanger W1.

A small partial stream (0.1 m³/h) can be removed from the cycle/circuit via the line 09 to reduce the water content in the purified scrubbing solution. This partial stream is heated in the heat exchanger W4 and subsequently in an additional heat exchanger W5 from 40° C. up to 160° C. and supplied to the vessel B2. The scrubbing solution is transported via the lines 10 and 11. The residual water is expelled from the scrubbing solution in the vessel and the steam escapes via the line 12. The hot scrubbing solution is drawn off from the vessel B2 and flows through the heat exchanger W4 as a heat carrier. A pump P3 is incorporated into the associated line 13. The purified scrubbing solution is cooled to normal temperature downstream of the heat exchanger W4 via the lines 14 and 15 and the heat exchanger W2 incorporated into these lines, and is mixed with the scrubbing solution supplied in the head of the scrubbing column K1.

If necessary, the anhydrous partial stream can also be added to the scrubbing solution of the second stripping column S2.

The water content of the biomethane produced can be further reduced to under 50 mg/Nm³ under the aforementioned conditions.

1-17. (canceled)

18. A method of purifying crude gases, including biogas, containing methane and hydrogen sulfide, the method comprising the following steps:
desulfurizing accruing crude gas and removing carbon dioxide from the crude gas by pressure scrubbing using a physically acting scrubbing solution supplied in countercurrent and dissolved in the scrubbing solution;
drawing-off purified biogas;
purifying laden scrubbing solution in at least two successive stripping stages including a first and a second stripping stage and thereafter supplying the purified laden scrubbing solution again to the pressure scrubbing;
treating the laden scrubbing solution accruing from the pressure scrubbing upstream of the first stripping stage in at least one flash stage; and
additionally purifying the gas mixture drawn off from the at least one flash stage containing nitrogen, oxygen, carbon dioxide and methane in a scrubbing stage using the purified scrubbing solution drawn off from the second stripping stage and supplied in countercurrent, producing a methane gas of high purity.

19. The method according to claim 18, which further comprises depressurizing the pressurized laden scrubbing solution in the at least one flash stage in a flash column by reducing a system pressure to a value of 1.5 to 5 bar.

20. The method according to claim 19, which further comprises increasing temperature of the laden scrubbing solution in the flash column by at least 5° C.

21. The method according to claim 19, which further comprises supplying residually laden scrubbing solution accruing at the bottom of the flash column and laden scrubbing solution accruing at the bottom of a scrubbing column of the scrubbing stage to a first stripping column of the first stripping stage and using stripping gas at an amount of 0.01 to 2% based on the amount of biogas to be purified being supplied to the pressure scrubbing.

22. The method according to claim 21, which further comprises carrying out the stripping at temperatures of 20 to 120° C. and a pressure of 1.5 to 5 bar, with at least 90% of the methane dissolved in the scrubbing solution removed.

23. The method according to claim 21, which further comprises supplying laden scrubbing solution from the first stripping stage to a second stripping column in the second stripping stage and depressurizing the laden scrubbing solution to standard pressure, and removing dissolved carbon dioxide still contained in the scrubbing solution using stripping air to at least a residual content of under 100 mg/l, producing a completely purified scrubbing solution.

24. The method according to claim 23, which further comprises dividing purified scrubbing solution accruing at the bottom of the second stripping column into two partial streams, supplying one partial stream to the scrubbing column and supplying the other partial stream to the pressure scrubbing.

25. The method according to claim 21, which further comprises desulfurizing the crude gas by supplying oxygenic stripping gas to the first stripping column and bringing the crude gas to be desulfurized into contact with a suspension, and providing the suspension with dissolved oxygen reaching the suspension by contact between the oxygenic gas mixture drawn off from the first stripping stage and the suspension.

26. The method according to claim 18, which further comprises, during desulfurization, converting scrubbed-out hydrogen sulfide to sulfuric acid (H₂S0₄) using biological materials through an intermediate step of sulfate (S0₄²⁻), hydrogen sulfate anion (HSO₄⁻).

27. The method according to claim 18, which further comprises dosing an amount of oxygen required for biological desulfurization through oxygen concentration of stripping gas supplied in the first stripping stage.

28. The method according to claim 18, which further comprises adding a gas mixture accruing after the first stripping stage to crude biogas in a quantity causing a ratio of gas mixture to crude biogas of 1:3 to 1:20 or 1:6 to 1:12.

29. The method according to claim 18, which further comprises using water or a polyglycol ether or a mixture of water and polyglycol ether as the scrubbing solution.

30. The method according to claim 18, which further comprises using residually laden scrubbing solution accruing after the first stripping stage as a heat carrier for heat generation.

31. The method according to claim 18, which further comprises removing a partial quantity of the purified scrubbing solution accruing in the second stripping stage, subsequently heating the partial quantity to temperatures of over 100° C. and supplying the partial quantity to a vessel in which residual water is expelled from hot scrubbing solution being added to the purified scrubbing solution again after being cooled.

32. A plant for carrying out the method according to claim 18, the plant comprising:
in the following order, at least one pressure scrubbing column, a flash column, a first stripping column and a second stripping column as well as an interposed scrubbing column;
said scrubbing column being connected through a line to a head of said flash column to supply a gas mixture containing nitrogen, oxygen, carbon dioxide and methane to said scrubbing column; and
said scrubbing column being connected through lines to a bottom of said second stripping column to supply a purified scrubbing solution.

33. The plant according to claim 32, which further comprises a unit for biological desulfurization of crude gas, said unit including a scrubbing column, a reaction vessel containing a suspension based on microorganisms and a circuit line having a pump, a line connecting said reaction vessel to said scrubbing column and a line supplying an oxygenic gas mixture to said reaction vessel.

34. The plant according to claim 32, which further comprises a unit configured to evaporate water from the purified scrubbing solution.
